(19) United States
(12) Patent Application Publication
(10) Pub. No.: US 2026/0139619 A1
(43) Pub. Date: May 21, 2026

(54) ENHANCED EFFICIENCY INTERNAL COMBUSTION ENGINE

(71) Applicant: Brian Schmidt, Galena, OH (US)

(72) Inventor: Brian Schmidt, Galena, OH (US)

(21) Appl. No.: 19/389,680

(22) Filed: Nov. 14, 2025

Related U.S. Application Data
(60) Provisional application No. 63/723,153, filed on Nov. 21, 2024.

(51) Int. Cl. F02B 75/04

(52) U.S. Cl. CPC F02B 75/048

(57) ABSTRACT

An enhanced efficiency internal combustion engine is described. The engine may include a piston and a gear assembly capable of causing the duration of a piston power stroke to exceed that of the piston's compression stroke. One example of the engine of the present invention involves a gear assembly with non-circular gear pairs at crank and output shafts. The non-circular gears may increase the duration of the piston down stroke per combustion event, and decrease the duration of the piston up stroke per combustion event, resulting in greater fuel efficiency of the engine. The engine may be employed in various different vehicles or other internal combustion engine-utilizing devices.

### CROSS-REFERENCE TO RELATED APPLICATIONS

This non-provisional patent application claims priority to U.S. Provisional Patent Application No. 63/723,153, filed Nov. 21, 2024, the disclosure of which is hereby incorporated by reference as if fully recited herein.

### TECHNICAL FIELD

The present invention relates generally to mechanical systems involving gears, and more particularly to an enhanced efficiency internal combustion engine involving at least one piston and gear assembly. One embodiment of the present invention involves non-circular gear pairs at crank and output shafts. The non-circular gear pairs may increase (or decrease) the duration of the piston down stroke per combustion event, resulting in greater fuel efficiency of the engine. An exemplary enhanced efficiency internal combustion engine may be employed in automobiles, powersport vehicles, small engines and equipment, trucks, construction vehicles, supply chain vehicles, some combination thereof, or the like.

### BACKGROUND AND SUMMARY OF THE INVENTION

The internal combustion engine is, generally speaking, a heat engine where fuel is combusted to drive a fluid flow circuit that directs force to an engine component that mobilizes an object the engine is integrated at. The force is often applied to a piston, which drives movement of other engine components linked to the piston. The internal combustion engine is generally reliable for delivering work in the form of torque, and has various applications in essentially every industry. An internal combustion engine may be powered by one or more of a variety of different fuels, including, for example, hydrocarbon-based fuels such as natural gas, gasoline, diesel fuel, and/or ethanol. It is desirable to have an internal combustion engine with high power output and fuel efficiency.

Fuel efficiency is, generally speaking, the ratio of one output unit of work performed for a given amount of fuel. For example, with automobiles, fuel efficiency is often expressed as the vehicle's miles per gallon (“MPG”). Although some developments have been made to address internal combustion engine fuel efficiency (e.g., MPG in various automobiles), fuel costs and the persistent need to refuel engines being used on a regular basis remain major issues for internal combustion engine device owners (e.g., automobile owners). Known internal combustion engines still suffer from less-than-optimal fuel efficiency, and known alternatives (e.g., electric or hybrid automobiles) have major drawbacks (e.g., high monetary costs, cumbersome charging requirements). As a result of less than-optimal fuel efficiency, known internal combustion engines often have high gas (particularly CO₂) emissions and waste heat. Known internal combustions also may suffer from a less-than-optimal response time (i.e., time required to move the object based on system input).

The aforementioned shortcomings speak to the need for an internal combustion engine that requires less fuel to perform a certain amount of work compared to a known internal combustion engine, and involves an improved response time, without requiring higher manufacturing and/or user costs.

In view of this, it is beneficial to have an enhanced efficiency internal combustion engine, various preferred embodiments of which are shown and described in detail herein. An exemplary engine may be employed in any number of different systems, such as, for example, automobiles, construction vehicles, supply chain vehicles, some combination thereof, or the like.

According to the present invention in one aspect, an exemplary internal combustion engine comprising one or more pistons is provided. The engine may comprise a crank shaft and an output shaft. The engine may further comprise at least one rod and gear assembly, wherein the rod may be configured to transmit force from the piston to the gears of the gear assembly to cause movement thereof. During the power stroke, piston-driven movement of the gears may cause torque of the output shaft. Thus, movement of the piston may cause torque of the output shaft during the power stroke. For the exhaust, intake, and compression strokes, the output shaft may be driving the crank (e.g., by way of inertia of a flywheel). Torque of the output shaft may cause movement of the object the engine is integrated at. For example, where the engine is integrated at a vehicle (e.g., automobile), torque of the output shaft may cause rotation of a plurality of wheels, which may dictate velocity of the vehicle.

Engine components may be configured to adjust each piston's up-stroke speed/duration and down-stroke speed/duration relative to the output shaft of the engine. System components may cause the stroke speed to decrease during a first event, and increase during a second event, all while maintaining a 1:1 ratio with the output shaft. The ability to adjust up and down-stroke speed/duration relative to the output shaft may optimize the stroke process to maximize work of the system for each rotation activity and combustion event. The adjustment may be caused by providing one or more non-circular gear pairs, each gear in mechanical communication with the other, where one gear of the pair is at the crank shaft, and the other gear of the pair is at the output shaft.

The one or more non-circular gear pairs at the gear assembly may increase the duration of the piston down stroke (e.g., by about 50%). The non-circular gear pairs may decrease the duration of the piston up stroke (e.g., by about 50%). The increase in the duration of the piston down stroke and decrease in the duration of the piston up stroke may cause the piston to effectuate more work of the system per each rotation activity and combustion event, resulting in greater fuel efficiency of the engine. The non-circular gear pairs may also improve the engine response time by increasing the duration of the down stroke and decreasing dwell time.

As a result of increased duration of piston down stroke, decreased duration of piston up stroke, and decreased dwell time, an exemplary engine may require a lower amount of fuel compared to a known internal combustion engine to perform the same amount of work. Likewise, an exemplary engine may perform a greater amount of work compared to the known internal combustion engine utilizing the same amount of fuel. The exemplary engine may be employed, for example, in a system that already utilizes an internal combustion engine (e.g., an automobile). The exemplary engine may also be employed, as another example, in a system that has not previously utilized an internal combustion engine (e.g., because fuel inefficiency and/or poor response time prevented or discouraged usage of an internal combustion engine in the past).

Advantages of an exemplary enhanced efficiency internal combustion engine may include, as non-limiting examples, improved fuel efficiency, improved response time, reduced fuel costs for users, reduced refueling instances for users, reduced emissions (e.g., reduced CO₂ emissions, reduced waste heat) (e.g., as a result of less fuel being combusted to perform a particular amount of work), reduced environmental impact (e.g., by way of reduced carbon emissions, reduced waste heat), some combination thereof, or the like.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a perspective view of an exemplary enhanced efficiency internal combustion engine of the present invention; and

FIG. 2 illustrates exemplary logic for an exemplary enhanced efficiency internal combustion engine of the present invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

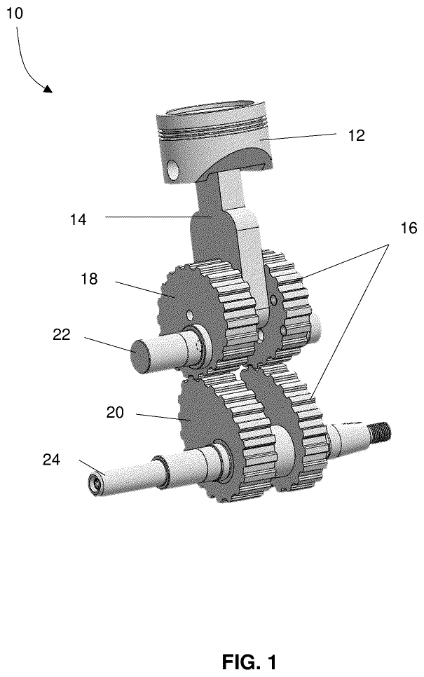

Referring now to FIG. 1, an exemplary enhanced efficiency internal combustion engine 10 is shown. For illustrative purposes, only the bottom half of the engine's 10 rotating assembly (the short block assembly) is shown. The engine 10 may include a piston 12, a rod 14, a gear assembly 16 (e.g., including first gears 18 and second gears 20), a crankshaft 22, and an output shaft 24. In this particular embodiment, each of the first gears 18 interact with one of the second gears 20, and each gear 18, 20 of the gear pairs is defined by a non-circular, round outer perimeter. In alternative embodiments, the shapes and/or movement paths of certain gears may be a different than those of FIG. 1. The present invention is not limited to any particular type, shape, size, material composition, design, location, and/or number of pistons, rods, gears, and/or shafts.

The piston 12 may be connected to an intermediate connecting rod 14. The rod 14 may be linked to the crankshaft 22. The first gears 18 may be positioned at (e.g., formed to, such as by molding or welding) the crankshaft 22. The second gears 20 may be in mechanical communication with the first gears 18. The second gears 20 may be positioned at (e.g., formed to, such as by molding or welding) the output shaft 24. The output shaft 24 may be in mechanical communication with a plurality of system wheels (not shown) and/or other system movement components. Gears may also be separate parts of a shaft or crank assembly, keyed to the shaft 22 or shaft 24 to maintain timing, and locked in place by fasteners. Any number of different intervening gears, shafts and/or other system components may be provided (based on system requirements) without departing from the scope of the present invention. The FIG. 1 embodiment and other embodiments may be employed in an automobile, although such is not required. The present invention is not limited to use with any particular vehicle or other engine-containing system.

Combustion of fuel (not shown) by known methods may cause reciprocal motion of the piston 12 and in turn the rod 14, which may cause rotation of the crankshaft 22 during a power stroke of the piston 12. Rotation of the crankshaft 22 may also contribute to reciprocal motion of the rod 14, and said rotation may be driven by the output shaft 24 (e.g., as a result of flywheel inertia) during the exhaust, intake, and compression stroke. Rotation of the crankshaft 22 may cause motion of the first gears 18, which may engage the second gears 20 to cause motion thereof. Motion of the second gears 20 may cause torque of the output shaft 24 during a power stroke, which may cause movement of the system (e.g., an automobile). In this particular embodiment, an aperture in each gear 18, 20 receiving a shaft 22, 24 is offset from the center of the gear 18, 20. The gears 18, 20 may be positioned on both sides of the rod 14 (e.g., to aid in balance, provide additional surface area of contact of gear teeth between both shafts 22, 24, provide additional functionality with little weight gain to the assembly, some combination thereof, or the like), although such is not required. Two different percentage ratio gear pairs may be provided on either side of the rod and an engagement system on the output shaft 24 (e.g., to permit a choice between which gear pair free spins, and which gear pair engages the output shaft). The ability to choose between different percentage profiles may further add efficiency at lower versus higher RPMs (revolutions per minute).

Each gear 18, 20 here is defined by a round, non-circular profile and outer perimeter, so as to preserve a 1:1 rotation ratio between gears. Here, the non-circular profiles and outer perimeters of the first gears 18 are different from the non-circular profiles and outer perimeters of the second gears 20, so as to maintain gear synchronization (e.g., during the second part of a piston cycle). The non-circular profile/outer perimeter of each gear may cause the first gears 18 to rotate along the second gears 20 when the piston 12 is moving downward for a longer (or shorter) duration compared to when the piston is moving upward. The increased duration of the power stroke may increase torque applied to the output shaft 24 during a combustion event, thus promoting fuel efficiency of the engine 10. The gear assembly 16 may provide for crank rotation about 50% offset with respect to crank rotation in an engine without said non-circular gear pairs. The overall shape and profile of each noncircular gear may be adjusted for various applications.

By increasing power stroke duration (and in turn decreasing compression stroke duration), the engine 10 may vary the speed of reciprocal motion of the piston 12 in relation to the output shaft 24 while maintaining a 1 to 1 ratio with the output shaft 24 (i.e., each cycle of movement of the piston 12 may remain the same as the rotation duration of the output shaft 24). The speed of the piston 12 at a given moment may depend on the position of each non-circular gear in a rotation pathway. At a first position, the speed of the piston may be lower. At a second position, the speed of the piston may be higher. An exemplary non-circular gear is not limited to the positioning illustrated herein, and may be linked to an exemplary piston in any number of different ways. As a few non-limiting examples, a non-circular gear may be linked to the piston by directly attaching a wrist pin of the piston to the gear (e.g., eliminating the rod), attaching the non-circular gear externally to the housing of the output shaft, some combination thereof, or the like. The overall design and size of the engine (e.g., 10) and its components may be adjusted/scaled to accommodate any number of different systems, which may each have strict piston number/stroke count requirements.

The gear assembly 16 having noncircular gear pairs may increase the power stroke duration by about 50% (respective to the output shaft, and compared to a gear assembly without said pairs), and decrease the compression stroke by about 50%. Piston dwell may be reduced by the gear assembly 16 by quick transitioning of the piston 12 from downward to upward movement, and vice versa. The gear assembly 16 may be configured to cause such quick transitioning. The particular configuration of the gears 18, 20 may be tuned/adjusted to achieve any number of different desired changes in piston speed/movement and dwell (e.g., gear shapes may be adjusted to regulate where across 360 degrees the gears are in their rotational pathways at a given time). This tuning/adjustment may provide for any number of different applications of an exemplary engine, and may provide any number of different benefits (e.g., accommodating different types of fuel, optimizing fuel usage, optimizing torque curve, dictating rotations per minute, regulating heat generated, optimizing air flow, spark optimization, some combination thereof, or the like).

Other components of the engine 10 may include piston timed components such as, for example, spark ignition control, camshafts for valvetrain movement, and the like. Certain piston timed components may be configured to accommodate and/or benefit from the non-circular gears and/or asynchronous reciprocal movement of an exemplary piston. Certain engine accessories (e.g., driven by the output shaft 24, such as, for example, an alternator, hydraulic pump, and the like) may also be configured to accommodate and/or benefit from the non-circular gears and/or asynchronous reciprocal movement of an exemplary piston. Depending on the configuration of the system the engine 10 is integrated at, and/or the number of pistons (e.g., 12) employed, one or more counterweights or other balancing components may be provided to balance the assembly at high rotational speeds.

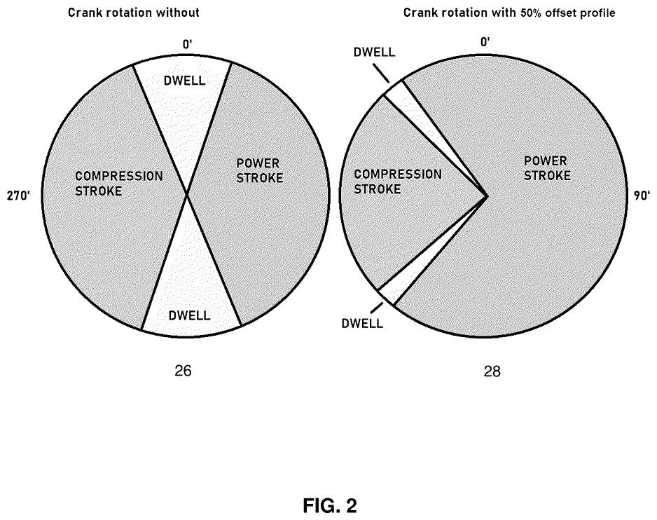

Referring now to FIG. 2, exemplary logic 28 for an exemplary enhanced efficiency internal combustion engine (e.g., 10 in FIG. 1) is shown. Here, the charts 26, 28 represent a single rotation of a four-stroke process, particularly, the first part of the process. The first chart 26 represents movement of a piston in a known internal combustion engine. The second chart 28 represents movement of a piston in an exemplary enhanced efficiency internal combustion engine. Here, the second chart 28 illustrates the duration of the piston down stroke of the exemplary enhanced efficiency internal combustion engine being about 50% higher than the piston down stroke of the internal combustion engine of the first chart 26. Likewise, the second chart 28 illustrates the duration of the piston up stroke of the exemplary enhanced efficiency internal combustion engine being about 50% lower than the piston up stroke of the internal combustion engine of the first chart 26. Accordingly, in this particular embodiment (and without accounting for dwell time as the piston changes direction), about 75% of the duration of the process is used for the power stroke, and about 25% of the duration of the process is used for the compression stroke.

The non-circular gear pairs may achieve these durations. The exact shape of the gears may be modified to adjust these percentages. For example, referring back to FIG. 1, the larger the offset portion of each gear 18, 20 relative to the portion having the shaft 22, 24, the greater the piston 12 down stroke duration, and the shorter the up-stroke duration. The 75%-25% durations exemplified in FIG. 2 may be optimized up or down by adjusting (e.g., redesigning) the profiles of a matched gear pair (wherein the total sum of duration percentages and dwells is equal to 100%).

The second part of the piston cycle in a four-stroke engine, which may involve an exhaust (upward) rotation and air-intake (downward) rotation, is not shown here. However, it will be appreciated that exemplary non-circular gear pairs at the crank and output shafts may also reduce the duration of the exhaust rotation. In the FIG. 2 embodiment, the air-intake rotation duration is about 50% higher than the exhaust rotation duration (as a result of the 50% offsetting shape of the gears). Exhaust gases may be very hot and fast moving, whereas intake air may be cool and slow moving. Because of the fast movement of the exhaust gases, it is acceptable here to reduce the duration of the exhaust rotation, and even beneficial for reducing lingering of unburnt fuel, improving cool air intake by increasing the duration during which cool air is drawn in, some combination thereof, or the like. Given the higher relative importance of cool air intake, it is beneficial to maximize cool air intake. Thus, the piston may perform the more important stroke (power and air intake strokes) of each the first and second stages of a four-stroke engine piston cycle slower and at a longer duration compared to the less important stroke (compression and exhaust strokes) (performed at a faster speed and slower duration).

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Although various exemplary embodiments are shown and described herein with reference to internal combustion engines, the present invention may also be applicable in other fields. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. An internal combustion engine system, the system comprising:
a piston, configured to engage in reciprocal motion;
a crankshaft in mechanical communication with the piston and a first gear assembly, the first gear assembly comprising at least one gear;
an output shaft in mechanical communication with a second gear assembly, the second gear assembly comprising at least one gear in mechanical communication with the first gear assembly; and
wherein at least one gear of at least one of the first and second gear assemblies has a non-circular outer perimeter adapted to cause a duration of a downward power stroke of the piston to be greater than a duration of an upward compression stroke of the piston.

2. The system of claim 1, wherein each gear of the first gear assembly and each gear of the second gear assembly has a non-circular outer perimeter.

3. The system of claim 1, wherein each gear of the first gear assembly is secured to the crankshaft.

4. The system of claim 1, wherein each gear of the second gear assembly is secured to the output shaft.

5. The system of claim 1, wherein each gear of the first gear assembly and each gear of the second gear assembly is keyed to the crankshaft or the output shaft.

6. The system of claim 1, wherein the output shaft is configured to cause movement of an automobile.

7. The system of claim 2, wherein each gear of first gear assembly and each gear of the second gear assembly includes an opening offset from a center of the gear, and wherein the crankshaft or output shaft is positioned at the opening.

8. The system of claim 1, further comprising a rod in mechanical communication with the piston.

9. The system of claim 8, wherein the at least one gear of the first gear assembly comprises a pair of gears including a first gear positioned at a first side of the rod, and a second gear positioned at a second side of the rod opposite the first side.

10. The system of claim 9, wherein the at least one gear of the second gear assembly comprises a pair of gears including a first gear in mechanical communication with the first gear of the first gear assembly, and a second gear in mechanical communication with the second gear of the first gear assembly.

11. The system of claim 10, wherein:
each gear of the first gear assembly is secured to the crankshaft;
each gear of the second gear assembly is secured to the output shaft; and
each gear of the first gear assembly has an outer perimeter profile that is different from an outer perimeter profile of a respective gear of the second gear assembly that is in mechanical communication with said gear of the first gear assembly.

12. The system of claim 1, wherein the piston is configured to have reciprocal motion speed thereof varied by a rotational position of the at least one gear of at least one of the first and second gear assemblies.

13. The system of claim 1, wherein the at least one gear of at least one of the first and second gear assemblies is configured to cause the duration of the power stroke of the piston to be more than twice the duration of the compression stroke of the piston.

14. An internal combustion engine apparatus, the apparatus comprising:
a piston, configured to engage in reciprocal motion;
a rod, connected to the piston;
a crankshaft in mechanical communication with the rod and a first gear assembly, the first gear assembly comprising at least one gear;
an output shaft in mechanical communication with a second gear assembly, the second gear assembly comprising at least one gear in mechanical communication with the first gear assembly;
wherein the piston is configured to engage in a downward power stroke to cause the rod to rotate the crankshaft and the at least one gear of the first gear assembly; and
wherein at least one gear of at least one of the first and second gear assemblies has a non-circular outer perimeter adapted to cause a duration of the downward power stroke of the piston to be greater than a duration of an upward compression stroke of the piston.

15. The apparatus of claim 14, wherein the crankshaft is configured to be rotated by movement of the output shaft during an exhaust, intake and compression stroke.

16. The apparatus of claim 14, wherein the at least one gear of the second gear assembly is configured to be rotated by the at least one gear of the first gear assembly to cause torque of the output shaft sufficient to move an automobile.

17. The apparatus of claim 14, wherein the at least one gear of at least one of the first and second gear assemblies is configured to cause the duration of the power stroke of the piston to be more than twice the duration of the compression stroke of the piston.

18. The apparatus of claim 17, wherein the at least one gear of at least one of the first and second gear assemblies is configured to cause the duration of the power stroke of the piston to be about three times the duration of the compression stroke of the piston.

19. An internal combustion engine system, the system comprising:
a piston, configured to engage in reciprocal motion;
a rod, connected to the piston;
a crankshaft mechanically coupled to the rod and a first plurality of gears;
an output shaft mechanically coupled to a second plurality of gears in mechanical communication with the first plurality of gears; and
wherein each gear of the first plurality of gears and each gear of the second plurality of gears has a non-circular outer perimeter adapted to cause a duration of a downward power stroke of the piston to be greater than a duration of an upward compression stroke of the piston, and to cause a duration of a downward air intake rotation of the piston to be greater than a duration of an upward exhaust rotation of the piston.

20. The system of claim 19, wherein the first and second plurality of gears are configured to cause the duration of the power stroke to be at least twice the duration of the compression stroke.
